(19) United States
(12) Patent Application Publication
(10) Pub. No.: US 2008/0176638 A1
(43) Pub. Date: Jul. 24, 2008

(54) Object oriented and real time electronic gaming device platform

(75) Inventor: Byron W. Goodman, Frisco, TX (US)

Correspondence Address: Byron W. Goodman, 6510 Abrams Rd., Suite 300, Dallas, TX, 75231, US

(73) Assignee: IHSoft, Ltd., Frisco, TX (US)

(21) Appl. No.: 11/657,242

(22) Filed: Jan. 24, 2007

(51) Int. Cl. A63F 13/00

(52) U.S. Cl. 463/25

(57) ABSTRACT

The invention, the Rad9 electronic computer platform, was developed to eliminate most of the complexity of developing casino games, since when developing a casino game, the vast majority of the design and development time is spent dealing with industry regulatory requirements, accounting requirements, backend system protocols and hardware interaction. The invention was developed to eliminate these problems from the development cycle, leaving only the game design and development.

With abstraction layers and a modular design, Rad9 provides unprecedented flexibility when dealing with changes in hardware, backend systems, and progressive systems, in which it is possible to exchange hardware systems, target board and backend systems without affecting the game code or requiring a recompile.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### COPYRIGHT NOTICE

A portion of the disclosure of this patent document contains or may contain material, which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND OF THE INVENTION

1. Field of the Invention

In general, the invention (as referred generally herein as “RAD 9” or “Rad9” and the same mark filed Apr. 21, 2006 under United States Trademark Application number 78866602) relates to a method of eliminating most of the complexity of developing casino games. The invention, the Rad9 real time electronic gaming device platform, is designed to support gaming systems and contains the essential software components needed for a gaming operating system for approval by regulated jurisdictions. With abstraction layers and a modular design, the invention provides unprecedented flexibility when dealing with changes in hardware, backend systems and progressive systems, in which it is possible to exchange hardware systems, target board and backend systems without affecting the game code or requiring a recompile.

2. Description of the Prior Art

Video gaming machines for wagering have been widely adopted by the gaming world as the successor to the traditional, reel-based, mechanical slot machine. The term “gaming”, as used herein, indicates that some form of wagering is occurring in the form of currency or an equivalent, e.g. tokens or credits.

The most basic purpose of a gaming apparatus is to display a randomly generated result and its associated payout. Currently, video gaming systems vary greatly in the way they generate the actual representation of a game and its associated results. At any given time, casinos can host hundreds of different games with equally varied features

Gaming machines do have some commonality. Most of them contain peripheral hardware systems, which communicate with the computer based control system through I/O interfaces. These peripherals include buttons, touch screens, credit management devices, coin acceptors, currency acceptors, card readers, and security devices. Most gaming machines employ I/O interfaces to communicate with external systems, such as accounting systems or casino computers.

Some of the protocols defined for I/O communication between the computer and the peripherals or external systems dictate real-time requirements. That is, a deadline between a communications event and its response.

The term “Computer” means a personal computer or embedded system, which includes a motherboard capable of loading commercial operating systems such as Microsoft Windows and Linux/Unix variants. The term “IO” or “I/O” means Input/Output, such as any hardware interface to a computer which provides a method of sending and receiving data. Some examples are serial ports, parallel ports, USB, Ethernet, and IEEE 1394 (also known as Firewire).

The term “software component” can refer to any software module or grouping of modules. A protocol module could be considered to be a type of software component, as could a complete operating system, or even a piece of an operating system. For this document, “software component” will be considered to be the set of code that an individual operating system vendor provides.

The term “Peripheral” means any hardware or software device which communicates with the game machine computer through hardware I/O interfaces.

The term “External system” is used to represent any complex external system which, while not necessarily a peripheral, still employs hardware I/O interfaces to communicate with the game machine computer. One example would be casino backend accounting systems.

When developing a casino game, the vast majority of the design and development time is spent dealing with industry regulatory requirements, accounting requirements, backend system protocols and hardware interaction.

Attempts have been made to create a universal gaming engine for a gaming machine and is described in Carlson U.S. Pat. No. 5,707,286. This patent describes a universal gaming engine that segregates the random number generator and transform algorithms so that this code need not be rewritten or retested with each new game application. Although the step of segregating random number generator code and transform algorithms has reduced the development time of new games, further improvements are needed.

This invention, Rad9, was developed to eliminate the previously mentioned problems from the development cycle, leaving only the game design and development. Rad9 handles almost all aspects of the final product, which are driven by regulatory requirements, leaving a much diminished set of requirements that affect the game design.

The nature of gaming systems and the stringent controls, applied to gaming systems and gaming applications by jurisdictional controls (e.g., Nevada State Gaming Commission, New Jersey State Gaming Commission, California State Gaming Commission, etc.), makes the development of the Rad9 real time electronic gaming device platform and the ability of the game developers to work with such a gaming operating platform unique within the field of computer based designer/developer interactions.

### BRIEF SUMMARY OF THE INVENTION

The present invention of the Rad9 real time electronic gaming device platform, consisting of the Rad9 Platform Interfaces, Game Interfaces, the Subsystems and peripherals, eliminates most of the complexity of developing casino games with respect to industry regulatory requirements, accounting requirements, backend system protocols and hardware interaction.

The Rad9 Platform provides a gaming-specific platform that features reduced game development time and an efficient gaming system that is cost effective for game software developers, gaming apparatus manufacturers and gaming apparatus users. The use of the Rad9 Platform will speed the review and approval process for games with the various gaming agencies, bringing the games to market sooner.

The Rad9 platform is designed to meet as many of the industry jurisdictional regulations as possible.

### BRIEF DESCRIPTION OF THE SEVERAL VIEWS OF THE DRAWING

These and other objects of the present invention will become evident from the following illustrations:

FIG. 1 is the Rad9 Design Block Diagram that shows the abstract representation of the Rad9 Platform Engine, the Platform Interfaces, Game Interfaces, the Subsystems and peripherals in the gaming platform apparatus that are the embodiment of the present invention.

FIG. 2 is a diagram illustrating an exemplary embodiment of the Rad9 Dynamically Linked Libraries (“DLLs”).

FIG. 3 is a diagram illustrating an exemplary embodiment of the list of the Software Development Kit (“SDK”) Header Files as part of the Rad9 Platform SDK.

FIG. 4 is a diagram illustrating an exemplary embodiment of the interface calls for the credit insertion related events of the IGameAdapter (reports game events) Method Call and descriptions that are specifically relevant to this invention.

FIG. 5 is a diagram illustrating an exemplary embodiment of the cash-out interface calls for the cash-out of credit events of the IGameAdapter Method Call and descriptions that are specifically relevant to this invention.

FIG. 6 is a diagram illustrating an exemplary embodiment of the button event calls to IInputadaptor of the IIputadapter (reports hardware events) Method Call and descriptions that are specifically relevant to this invention.

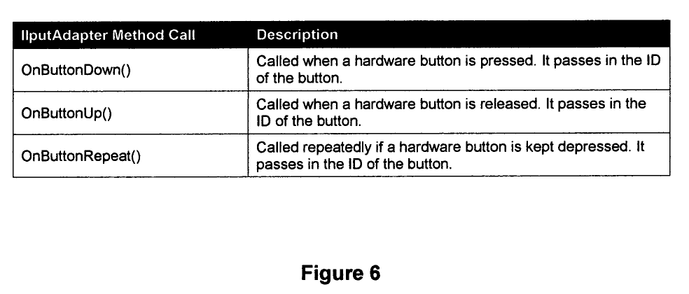

FIG. 7 is a diagram illustrating an exemplary embodiment of the interface calls for the credit insertion related events of the IGameAdapter Method Call and descriptions that are specifically relevant to this invention.

FIG. 8 is a diagram illustrating an exemplary embodiment of the denomination related IgameSettings (game settings) Methods call and descriptions that are specifically relevant to this invention.

FIG. 9 is a diagram illustrating an exemplary embodiment of the interface calls in IgameReflex (entry point for game requests) for the non-volatile storage method calls and descriptions that are specifically relevant to this invention.

FIG. 10 is a diagram illustrating an exemplary embodiment of the IplayLog (stores log of games played) Method calls and descriptions that are specifically relevant to this invention.

FIG. 11 is a diagram illustrating an exemplary embodiment of the IEmulator (calls generated from hardware peripheral or platform subsystem) Method calls and descriptions that are specifically relevant to this invention.

### DETAILED DESCRIPTION OF THE INVENTION

In the following detailed description of sample embodiments of the invention, reference is made to the accompanying figures that form a part hereof, and that is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical and other changes may be made without departing from the spirit or scope of the present invention. It is essential to an appreciation of the practice of the present invention that the jurisdictional approval requirements and the industry standards of the gaming industry be considered in determination of the skill and technical sophistication of the present technology and invention.

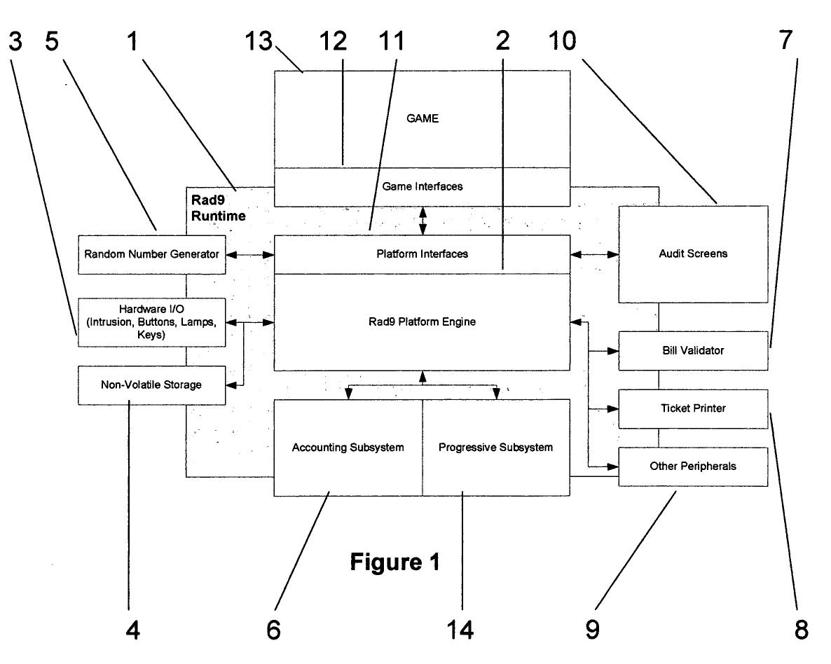

FIG. 1 shows the Rad9 Design Block Apparatus Diagram, a schematic block diagram of the electronic configuation of the gaming platform embodiment of the present invention.

FIG. 1 illustrates the Rad9 Runtime.1 The Rad9 Runtime is responsible for the orderly construction of the full system and provides many of the facilities employed by the various systems. The library housing the runtime, Radix.dll, also provides most of the utility classes for the overall development of the Engine and its peripherals

The center of the Rad9 Platform is the “Rad9 Platform Engine,” 2 which is responsible for all the complex interaction between the various subsystems and peripherals, and operates almost every aspect of casino gaming pertinent to video slot machines and handles most of the industry regulatory requirements. The Rad9 Engine 2 is distributed as a DLL named RadixEngine.dll.

The Board Support Package (“BSP”) is usually a DLL containing implementations of certain subsystems, which are specific to the chosen target hardware system. BSPs usually implement interaction with hardware buttons, intrusion detection (doors), lamp control, key switches 3 and non-volatile storage.4 One example of a BSP is the DensitronDPX116.dll that contains the implementation of the sub-systems above for a Densitron DPX-116 based system.

Among the many jurisdictional regulatory requirements, which a casino video slot machine has to meet, is the requirement that the random number generator (“RNG”) 5 be tested and approved by a regulatory laboratory and it has to be based on solid mathematical theory. The Rad9 platform provides access to an approved RNG 5 to be used by the game for its random number needs. The RNG 5 is contained in the RadixRNG.dll and its implementation is based on the Mersenne-Twister pseudorandom number generator theory.

The Accounting Subsystem 6 usually involves interaction with a complex backend system, using either a serial protocol or an Ethernet based protocol. Accounting Subsystems 6 drive many of the internal requirements of the Rad9 Platform, since they are the most demanding of the subsystems. Testing interactions with these casino systems accounts for a good portion of laboratory testing time. The most common implementation is that of the IGT's Slot Accounting System (SAS) v. 6.01, which is contained in SAS.dll.

Video slot systems have some common peripherals, such as bill/voucher validators, 7 ticket printers, 8 coin hoppers and coin acceptors.9 Specific implementations of these peripherals are delivered as independent DLLs. Examples of these are the JCMWBA.dll which implements a JCM WBA bill validator and the Ithaca850.dll which implements an Ithaca 850 ticket printer.

The invention provides a DLL that contains emulated versions of some of the critical subsystems for development purposes. The RadixEmulation.dll contains emulated versions of a bill validator,7 ticket printer,8 Accounting Subsystem 6 and hardware I/O.3 This should allow the Engine to be launched successfully, even in a development workstation with no hardware.

There are many regulatory requirements directed at what information should be present in audit screens. The Rad9 Engine includes an abstract interface for the implementation of third-party audit screens,10 but it also provides a default Win32 implementation of the audit screens, 10 which meets all the main jurisdictional requirements.

The Rad9 Platform provides abstract interfaces 11 for the interaction between the Platform 11 and the game 12 interfaces, which are designed to hide most of the inner details of the Engine and its peripherals.

The game 13 must implement the game-side abstract interfaces 12 provided by the Rad9 Platform.

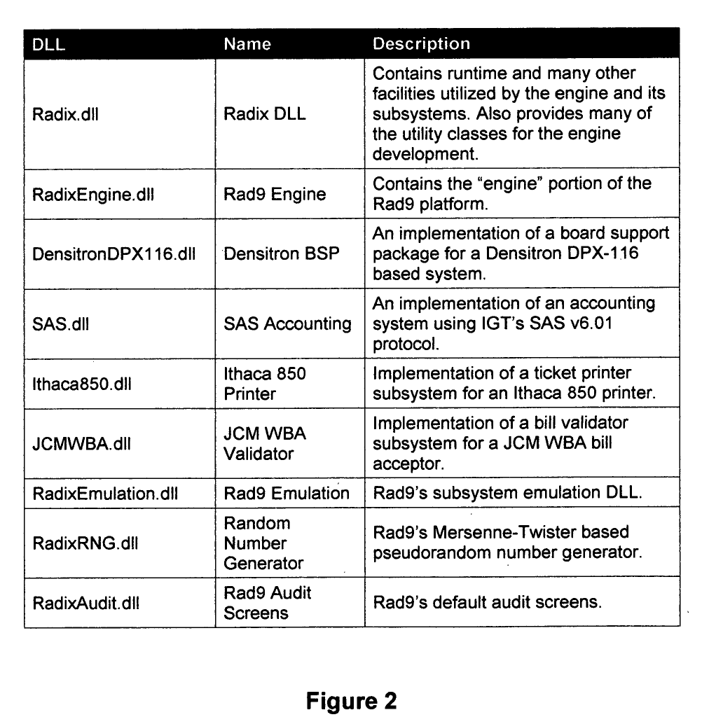

FIG. 2 lists some of the DLLs that might be encountered while using the Rad9 Platform.

Rad9 provides abstract interfaces for the implementation of the game as well as interaction with the Platform. The interface classes are game-side interfaces 12 and engine-side interfaces 11 as shown in FIG. 1.

Game-side interfaces (the IGame Adapter, the IInput Adapter and the IPlay Log) 12 are used by the Engine to communicate events which the game has to react to. The IGameAdapter class is the abstract interface to the implementation of the game 13 and contains all methods necessary for the Rad9 Engine to inform the game 13 of all relevant events. The IInput Adapter, which is implemented by the game-side,12 is used by the Engine 2 to report hardware button events 3 and any future hardware events that must be passed on directly to the game 13 will be added to this interface.12 The IPlayLog is used for regulatory purposes, since the game must store a log of game plays and be able to recall any of those games to display, either textually or graphically, what the result of the game was. Since game recall is usually carried out through secure audit screens,10 the game must implement this interface 12 in order for the Engine to be able to control when games are recalled.

The Engine-side interfaces 3, 4, 5 (the IGameReflex, the IGameSettings, the IGame State, the IEmulator, the INonVolatileStream and the IRandom) are implemented by the Engine 2 and are used by the game to request actions from the Engine and to retrieve critical information. The IGameReflex is the abstract interface 3 to the Rad9 Engine 2 and provides an entry point for the game to make any requests of the Engine. Through this interface, the game can get access to other utility interfaces, such as the IRandom (RNG abstract interface) class, IGameSettings class and the IEmulator class. The IGameSettings provides access to certain settings, which are controlled by the Rad9 Engine and is used to set some game related settings that the platform must keep record of. The IGameState is implemented by the Platform and is used by both the game 13 and the Engine 2 to maintain the current state of credits in the game machine. The IEmulator interface allows the game to make calls to the Engine that cause events which are usually generated from hardware peripheral 3 or platform subsystem. The use of this interface should be strictly employed for development and lab testing purposes only and should not be available to the casinos or players at any time. The INonVolatileStream provides the game developers with access to a non-volatile storage 4 implementation of a stream. This specialized stream takes care of meeting all regulatory requirements, while providing a more commonly used stream-like interface. The IRandom is the interface for an approved platform supplied random number generator.5 Random number generator implementations are independently tested by regulatory laboratories for compliance.

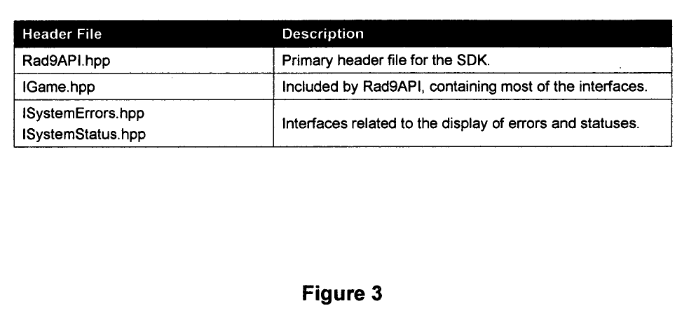

FIG. 3 shows the header files that are included with the Rad9 Platform SDK, referred to as the RAD9 Runtime 1 illustrated in FIG. 1. To initialize the Rad9 Runtime,1 use the static Rad9API::Initialize( ) call. This call takes in a pointer to the implementations of the IGameAdapter and IInputadapter interfaces. When the Rad9 Platform 11 has been initialized, it will call the game adapter's IGameAdapter::OnInitialize( ) Method, which includes a pointer to the Platform's implementation of IGameReflex. Once the Rad9 Runtime 1 has been initialized, use the Rad9API::Run( ) Method to kick off the system. This is a blocking call, which will only return upon system shutdown. In this scenario, the IGameAdapter is serviced by the Rad9 Engine 2 by use of the IGameAdapter::OnService( ) Method. The Rad9 Platform provides a method for the game implementation to request a system shutdown by Rad9API::Shutdown ( ). When this call is made, the Rad9 Runtime 1 will halt its Run( ) call and return. In order to destroy the Runtime and all its systems, call Rad9::Release( ).

The Rad9 Engine 2 supports multi-denomination games, in which the player may change the base denomination for the game credits. The game can retrieve the current system denomination by calling IGameState's GetCurrentDenom( ) Method. If it's a multi-denom enabled game, it can request a change in denomination by calling IGameReflex::RequestDenomChange( ), which returns true if the denomination was changed or false if for any reason it could not change the denom. The game denomination and credits are optional for the player's benefit, since a game implementation could display everything in currency.

Since credits are displayed for the benefit of the player or the casino, the Rad9 Engine 2 deals in 1/100^{th} (cents) of the set system currency. Credits are defined as the base accounting credit. All interface transactions with the Rad9 Engine 2 are in this ‘currency’.

If the amount of money in the game machine does not divide evenly with the current game denomination, the remaining cents are called “residual credits.” There are two ways of handling the residual credits: 1) they can be cashed out automatically if the casino has enabled this feature, or 2) they remain in the engine's current credits meter. For the second option, if the current amount of money on the machine falls below the amount of a single credit (e.g. the player has only 0.5 credits left), then the game 13 is responsible for letting the player know that, even though he has ‘0’ credits on the machine, he has some actual money left on the machine that he can cash out.

For purposes of the Rad9 Engine,2 there is a start of a game, where money is bet, and an end of the game, where money is possibly awarded. Once the game is ready to trigger a game sequence, set the amount being bet by calling IGameState's SetBetCurrent( ) and then request the start of a game with IGameReflex::RequestGameStart( ). Some backend features are triggered when a player is betting the maximum wager for the current game. The IGameState::SetBetMax( ) sets the bet amount which is considered a ‘max bet’. This Method returns a bool which, if true, means that the game request was accepted. If it returns false, it signals that the engine currently cannot play a game. There are a large number of reasons why this could happen, actions like inserting credits and cashing out or system failures like communication errors and hardware failures. When a game request is accepted, the engine will process the request and asynchronously respond to the game by calling IGameAdapter::OnPlayBegin( ). Included in the call is a reference to the IRandom interface for ease of use. The act of the Engine calling OnPlayBegin( ) constitutes an acknowledgment that the whole system is now playing a game, before this time, a game has not officially started.

Once OnPlayBegin( ) is called, the game can freely execute the result of the game, play bonus games, etc. Once the game sequence has come to an end, the game will signal that its ready to officially finalize the game by calling IGameReflex::RequestGameEnd( ). The only parameter for that call is the amount won in cents. The Engine will now award the appropriate payout and finalize any accounting responsibilities. It will eventually respond by calling IGameAdapter::OnPlayEnd( ) which includes a reference to IGameState. From the game state the game can extract information such as the credits (in cents) officially won on the game that just finished and the current number of cents in the game machine's credit meter. It is possible for the credits won on the game state to be different to the amount reported in RequestGameEnd ( ). This is because certain backend system can affect the payout through different types of bonuses. The game should wait for this information before displaying the final amount won in the game.

The Rad9 Engine 2 is solely responsible for keeping account of all meters, including the current credit meter. The IGameState interface can be used to retrieve the official current credits at any time. This eliminates the possibility of a discrepancy between the accounted credits and the credits displayed on the screen.

After the OnPlayEnd( ) call, the system is officially finished with the play sequence and the game is free to display any final payout animations and return to the “idle” state for the player's next move.

The Rad9 Platform supports two types of external bonuses. These are bonuses that are generated externally to the game machine, originating from backend casino accounting or bonus systems.

The bonus award is simply an amount of credits (cents) being awarded to the player for some casino-specific reason. It occurs at any time the game machine is idle or has finished a game. The engine calls IGameAdapter::OnBonusAward( ) with the amount awarded. The game displays the fact that the award was given and for how much, but it does not add the amount to the current credits. A call to IGameAdapter::OnGameStateChange( ) occurs soon after reporting a change in the current credits available to the player. This last call triggers a refresh of the current credits available to the player. A bonus award does not interfere or in any form change the result of a game.

For the multiplier award, a backend system sets up a certain window of a win amount range to be multiplied as a bonus. The Engine calls IGameAdapter::OnMultiplierAward( ) and includes the multiplier and the new win amount for display purposes. The multiplier award changes the result of the game and the OnPlayEnd( ) call would return an IGameState object with a different win amount than what was reported in the RequestGameEnd( ) call.

Casinos set a trigger against large single-game wins that causes a handpay to occur. A handpay has two basic purposes; one is to meet federal tax requirements and the other to provide a verification mechanism in which intervention by a casino attendant is required. Usually a handpay causes a game to lockup and display a handpay dialog. Once the casino attendant deals with the handpay, the system is reset. In terms of a game play sequence, a handpay may be triggered due to the RequestGameEnd( ) call. This would cause a delay of the IGameAdapter::OnPlayEnd( ) callback until the handpay has been completed. Another side effect would be that the IGameState will show the total amount of the win, but the current credits will not reflect the win. This is because handpays are usually paid out directly to the player and are not added to the current credits meter.

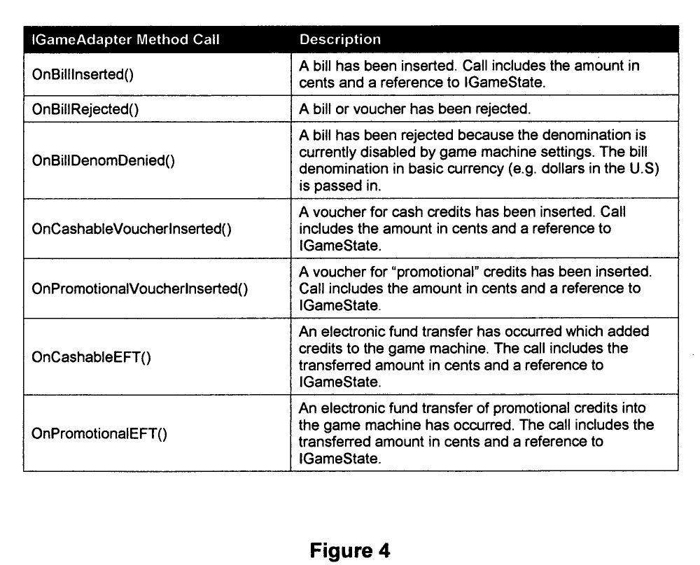

Rad9 notifies the game of a change in game state. This message is the IGameAdapter::OnGameStateChange( ) which passes along a reference to IGameState. The Engine employs interface calls to give more specific information to the game for display purposes as illustrated in FIG. 4.

When the player requests a cashout, the game uses the IGameReflex::RequestCashout( ) Method. The Method returns “true” if the engine is in a state where it is able to accept the request; it returns “false” otherwise. On a cashout request, the Engine attempts to cash out all of the players cashable credits in whatever form it can. The cashout could take the form of a cashout ticket, a cashout handpay, an EFT, or a hopper payout. Cashout events may be automatically triggered by other factors. One example is the cashout of residual credits, if it is enabled in the system settings. Any time the amount of currency does not divide evenly with the current game denomination, the residual is automatically cashed out.

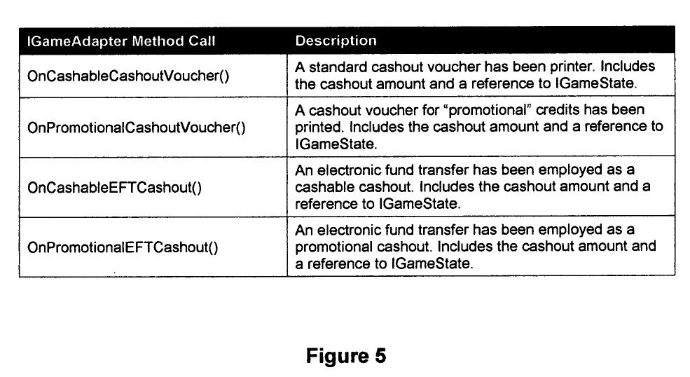

After a cashout of any type occurs, the Engine will call IGameAdapter::OnGameStateChange( ) to signal a change in the current credits. It will make a call to the event method to indicate what type of cashout occurred for display purposes, these are illustrated in FIG. 5.

When the game machine is offline for any reason, the Rad9 Engine 2 signals the event by calling IGameAdapter::OnGameOffline( ). While offline, no new games can be played. The only action available to the player is to request a cashout. If the offline event occurs in the middle of play, the game shall finish with the current sequence and finalize the game. Once the game is ended, no other play is allowed until the system is back online. When the system returns to normal operation, the Engine calls the OnGameOnline( ) method to signal the event. While offline, the Rad9 Engine reports the error conditions to the game so that it is able to display the error codes and descriptions on-screen.

The attendant may lock out a machine from use through the audit screens,10 in which case the game will be informed by the IGameAdapter::OnAttendantLockout( ) call. The system functions the same as if offline, except it will inform the player that the machine is currently out of service and should cash out. The canceling of an attendant lockout is done by the IGameAdapter::OnLockoutCancelled( ) call.

The accounting lockout is very similar to an attendant lockout, except it is caused by the backend system. The game will act the same as if it is offline, with the exception it will inform the player that the machine is currently out of service and should cash out. The call for an accounting lockout is IGameAdapter::OnAccountingLockout( ). An accounting lock is cancelled by the same IGameAdapter::OnLockoutCancelled( ) call used for the attendant lockout, since the Rad9 Engine 2 allows an accounting lockout to supersede an attendant lockout.

For a NVM Corrupt Lockout, there are very specific requirements that all non-volatile storage 4 needs to be able to detect corruption of any kind. The Rad9 Engine 2 handles this for the whole system and can detect where the storage of state between game and platform have become incompatible. The engine will call IGameAdapter::OnNVMCorruptLockup( ). This is a catastrophic event which requires an attendant to approve an NVM reset. The game's only action is to display that an NVM corruption has been detected and completely lock out the system so that no interaction with the player can occur.

When the game machine goes offline, it is usually accompanied by a signal from the Engine that errors need to be displayed. The IGameAdapter::OnErrorCondition( ) call is employed for this and passes a reference to an ISystemErrors object. The ISystemErrors class allows the game to get a list of error strings to display. Any time this list changes, OnErrorCondition( ) is called once again. When it is called with no error strings present, it can be taken as a signal that no error condition currently exists. Errors are prominently shown on-screen for the benefit of the casino attendant who must correct the problem.

A Status signal can occur at any time and does not signify that the machine is offline. The IGameAdapter::OnStatusCondition( ) signals a change in the current status. It passes in a reference to an ISystemStatus object, which contains a list of strings to be displayed. These strings should be displayed somewhat discretely since they should be visible to an attendant, but not interfere with the game experience because most of them will stay present during at least one game. When an update is sent with no strings, it means no status signals are currently pending and nothing needs to be displayed.

Audit screens 10 are used to provide the casinos with access to auditing data, event logs, meter values, etc. Through an extra level of access, they can also get access to the system setup features. Access to audit screens 10 is controlled by the Rad9 Engine.2 The game gets notified of audit screen access with the IGameAdapter::OnAuditEnter( ), at which time it should freeze completely (even if its in the middle of a game sequence) and wait for the IGameAdapter::OnAuditExit( ) call to resume.

Demo mode is a specialized mode usually employed for marketing purposes. When a game is played in demo mode, it is not exercising any of the official accounting features of the engine. In essence, the player is playing a dummy game. A system is set into this mode through the audit screens.10 When this occurs, the game is notified by the IGameAdapter::OnDemoMode( ) call. The game's only responsibility is to clearly mark that the system is in demo mode.

Test mode is meant for use by regulatory laboratories to enable any feature required by them. One example would be to directly affect the result of a game for testing purposes. When the system is set into test mode, the Engine will call IGameAdapter::OnTestMode( ). Once in test mode, the game is allowed to enable any test features it has implemented. While in test mode, the Engine is still using the full spectrum of accounting features, just like if it where in normal operation.

Normal mode is used to return the system to normal casino operation. When this occurs, the Engine calls IGameAdapter::OnNormalMode( );

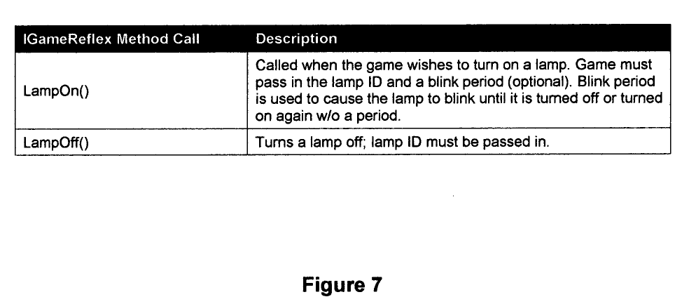

Button events are sent to the game through the use of the IInputadapter interface. Events include a button ID which is somewhat arbitrary and is based on the particular game being implemented. The Board Support Package allows the game developer to set the hardware buttons to whatever IDs are desired. FIG. 7 illustrates the button events sent to IInputadapter

Almost all casino slot machines employ lamps for button lighting purposes. The IGameReflex interface allows the game to control the state of these lamps using the calls in FIG. 7. Similar to buttons, the lamp IDs are arbitrary and usually are set by the board support package.3

Certain settings owned by the Rad9 Engine 2 are made available to the game through the IGameSettings interface. This interface can be obtained by the IGameReflex::GetGameSettings( ) call. IGameSettings also includes some interface Methods which allow the game to change some of these settings. The Engine allows some of these settings to be changed through the audit screens.10 When this occurs, the game will be informed that the content of IGameSettings might have changed by calling IGameAdapter::OnSettingsChange( );

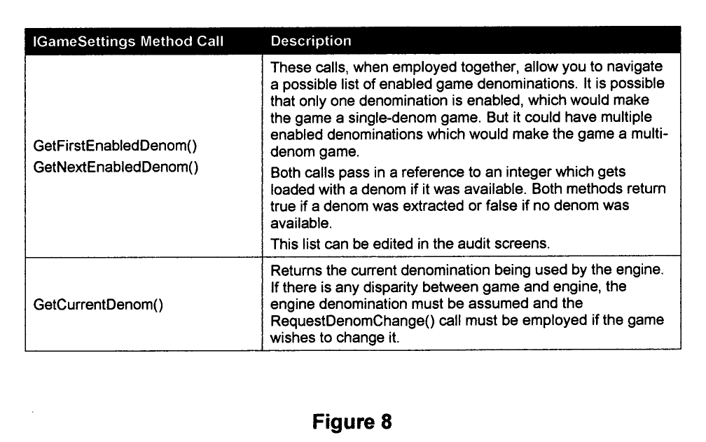

A game only supports one denomination, but if a game is implemented as a multi-denomination game, then the player is allowed to select the base denomination for their credits. Even though ‘credits’ and ‘denomination’ are purely game-side concepts, the Engine maintains control of the denomination for reporting purposes and for certain automated features, like ‘residual credits’ cashouts. FIG. 8 illustrates denomination related IGameSettings methods. If the Engine must change the current denomination, the Engine notifies the game by calling the IGameAdapter::OnDenomChange( ) method.

Because of regulatory requirements, the game must report its version string to the Rad9 Engine 2 as part of its initialization responsibilities. Use the IGameSettings::SetGameVersion( ) call to do this. Some jurisdictions allow casino video slots to support an autoplay feature. Autoplay is usually activated by the player and causes games to be automatically started as long as the feature is active. The IGameSetings::GetAutoplayEnabled( ) call retrieves from the Engine, if the feature is enabled at all by the casino. If it returns false, it means that the casino does not wish the game to allow a player to use its autoplay feature.

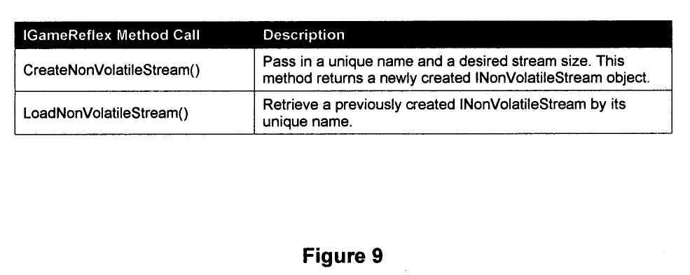

Casino slot machines require some type of non-volatile storage 4 for settings, logs, system restore and many other purposes. Since jurisdictional requirements on what can be used for non-volatile storage vary greatly, the Rad9 Engine 2 provides a specialized abstract interface for the game to be able to meet its non-volatile storage needs. The primary need of a game for non-volatile storage 3 is driven by the system restore feature, but it can be employed for any other purpose which requires non-volatile storage.3 The INonVolatileStream interface describes a typical stream with standard Seek( ), Pos( ), Length( ) , Read( ) and Write( ) methods. It also provides helper methods for type specific Reads and Writes. The Save( ) method causes the current data in the stream to be stored in non-volatile storage in the format used to meet regulatory requirements. Save( ) must be called after making changes to date through the INonVolatileStream interface, in order to have the stream's data be stored in non-volatile memory.4 Two interface calls in IGameReflex are provided for this feature. FIG. 9 illustrates the non-volatile storage Methods.

With respect to system restoration, if a reel based game gets the IGameAdapter::OnPlayBegin( ) call from the engine, it saves in non-volatile storage its state variables and proceeds to animate the reels. If the game where powered down at this point, it would have to restore to the state where the reels where spinning. In this case the Rad9 Engine automatically starts up in the ‘playing game’ state.

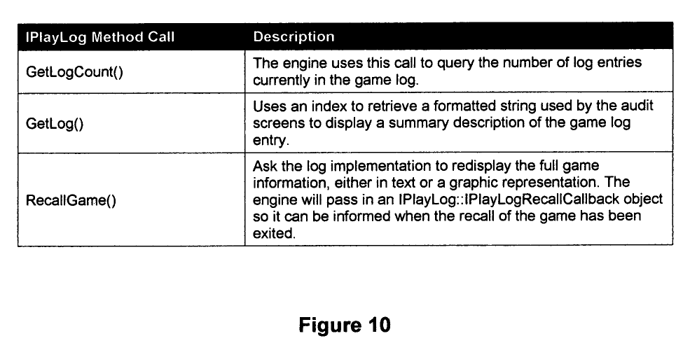

Under regulatory requirements, a certain number of games must be stored in a log and that these games must be recallable through the audit screens.10 Most jurisdictions require storage of at least 50 entries. If a game sequence can contain any type of bonus games, free spins, or the like, each ‘step’ of the game must be stored in separate entries so they can be individually recalled. The game developer is responsible for implementing the IPlayLog interface and registering it with IGameReflex using the RegisterPlayLog( ) method illustrated in FIG. 10. Through it, the Rad9 Engine 2 can retrieve information about the log for display purposes and can request a game to be recalled.

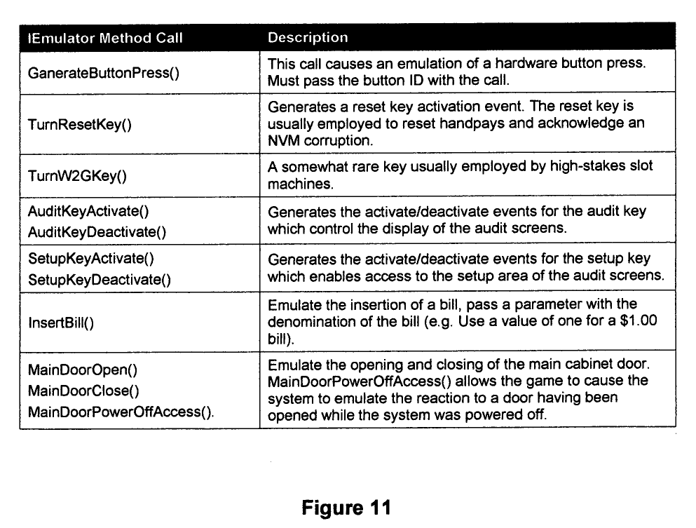

The Rad9 Engine 2 provides a facility to the game for generation of emulated hardware events. As illustrated in FIG. 11, the Emulator Calls are only used for development purposes and are not available during normal system operation.

Some jurisdictions require an audible alarm to be played under certain conditions. When this alarm needs to be played, the Rad9 Platform calls IGameAdapter::OnPlayAlarm( ). To cancel the alarm, it will send OnCancelAlarm( ).

A casino slot machine may allow the player to call for assistance by turning on the attendant lamp (sometimes called the change light). Usually the player does this through a hardware button 3 or an on-screen button. The game can request this by calling IGameReflex::CallAttendant( ) and cancel it by calling CancelCallAttendant( ).

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is thus to be understood that the invention is not limited to the disclosed embodiments, but modifications and variations in the present invention may be made without departing from the novel aspects of this invention as defined in the claims. It is intended that this invention be limited only by the claims, and the full scope of equivalent arrangements included within the spirit and scope of the claims.

The invention claimed is:

1. A computerized gaming platform apparatus, comprising:
the Rad9 Platform Interfaces, Game Interfaces, the Subsystems and peripherals, that operates casino games within the application of industry regulatory requirements, accounting requirements, backend system protocols and hardware interaction.

2. The method of claim 1, wherein the center of the Rad9 Platform is the “Rad9 Platform Engine,” which is responsible for all the complex interaction between the various subsystems and peripherals, and takes care of almost every aspect of casino gaming pertinent to video slot machines and handles most of the industry regulations.

3. The method of claim 2 wherein the board support package is Dynamically Linked Libraries containing implementations of certain subsystems, which are specific to the chosen target hardware system and implement interaction with hardware buttons, intrusion detection (doors), lamp control, key switches and non-volatile storage.

4. The method of claim 3 wherein the invention provides access to an approved random number generator to be used by the game for its random number needs.

5. The method of claim 4 wherein the invention has an accounting subsystems to drive many of the internal requirements of the Rad9 Platform.

6. The method of claim 5 wherein the invention has the specific implementations of peripherals, such as bill/voucher validators, ticket printers, coin hoppers and coin acceptors, delivered as independent Dynamically Linked Libraries.

7. The method of claim 6 wherein the invention provides Dynamically Linked Libraries that contain emulated versions of some of the critical subsystems for development purposes.

8. The method of claim 7 wherein the Rad9 Engine includes an abstract interface for the implementation of third-party audit screens, but it also provides a default Win32 implementation of the audit screens, which meets all the main jurisdictional requirements.

9. The method of claim 8 wherein the Rad9 Platform provides abstract interfaces for the interaction between the platform and the game interfaces, which are designed to hide most of the inner details of the engine and its peripherals.

10. The method of claim 9 wherein the invention provides abstract interfaces for the implementation of the game as well as interaction with the platform, having Game-side interfaces and Engine-side interfaces.

11. The method of claim 10 wherein Game-side interfaces are used by the Engine to communicate events necessary for the Rad9 Engine to inform the game of all relevant events, to report hardware button events, to recall any of the game and to display, either textually or graphically, what the result of the game was.

12. The method of claim 11 wherein the Engine-side interfaces are implemented by the Engine and are used by the game to request actions from the Engine and to retrieve critical information, to provide an entry point for the game to make any requests of the Engine, to obtain access to other utility interfaces, to provides access to certain settings which are controlled by the Rad9 Engine, to set some game related settings that the platform must keep record of, to maintain the current state of credits in the game machine, to make calls to the Engine that cause events which are usually generated from hardware peripheral or platform subsystem and to supply random number generator.

13. The method of claim 12 wherein the Rad9 Engine supports multi-denomination games, in which the player may change the base denomination for the game credits.

14. The method of claim 13 wherein the Rad9 Engine is responsible for keeping account of all meters, including the credit meter.

15. The method of claim 14 wherein the Rad9 platform supports two types of external bonuses that are generated externally to the game machine originating from backend casino accounting or bonus systems.

16. The method of claim 15 wherein the Rad9 Engine notifies the game of a change in game state.

17. The method of claim 16 wherein the Rad9 Engine provides a specialized abstract interface for the game to be able to meet its non-volatile storage needs and the current data in the stream to be stored in non-volatile storage in the format used to meet regulatory requirements.

18. The method of claim 17 wherein the game developer through the Rad9 Engine can retrieve information about the log for display purposes and can request a game to be recalled.

19. The method of claim 18 wherein the Rad9 Engine provides a facility to the game for generation of emulated hardware events that are used for development purposes and are not available during normal system operation.

20. The method of claim 19 wherein the Rad9 Platform for the required jurisdictions play an audible alarm under certain conditions.

21. The method of claim 20 wherein the Rad9 Platform on-screen button can request or cancel assistance.
